(19) United States
(12) Patent Application Publication
(10) Pub. No.: US 2009/0257147 A1
(43) Pub. Date: Oct. 15, 2009

(54) PERPENDICULAR MAGNETIC RECORDING MEDIUM AND MAGNETIC RECORDING APPARATUS

(75) Inventor: Antony Ajan, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/488,035

(22) Filed: Jun. 19, 2009

Related U.S. Application Data
(63) Continuation of application No. PCT/JP2007/053827, filed on Feb. 28, 2007.

(51) Int. Cl. G11B 5/127; G11B 5/667

(52) U.S. Cl. 360/125.02; 428/828.1; G9B/5.04

(57) ABSTRACT

A disclosed perpendicular magnetic recording medium includes a substrate; a soft magnetic underlayer disposed on the substrate and having no remanent magnetization; and a ferromagnetic recording layer disposed on the soft magnetic underlayer. The soft magnetic underlayer includes at least three soft magnetic layers laid one above the other with a non-magnetic intermediate layer interposed between every two adjacent soft magnetic layers. Among the (at least) three soft magnetic layers, at least one pair of soft magnetic layers form ferromagnetic coupling. Among the (at least) three soft magnetic layers, at least one pair of soft magnetic layers form antiferromagnetic coupling.

### CROSS-REFERENCE TO RELATED APPLICATIONS

The present application is a continuation application filed under 35 U.S.C. 111(a) claiming benefit under 35 U.S.C. 120 and 365(c) of PCT International Application No. PCT/JP2007/053827, filed on Feb. 28, 2007, the entire contents of which are incorporated herein by reference.

### FIELD

The present disclosure is directed to a perpendicular magnetic recording medium, a method for manufacturing the same, and a magnetic recording apparatus, and in particular to a perpendicular magnetic recording medium having a magnetic layer in which magnetic particles are separated by a nonmagnetic material.

### BACKGROUND

A magnetic recording apparatus, such as hard disk device, is widely used as a digital signal recording apparatus in personal computers and the like due to its low unit price per bit and large recording capacities. In recent years, hard disk devices have also been used in acoustic imagery-related applications. With this trend, there is dramatic growth in demand for hard disk devices. On the other hand, for video signal recording, there is demand for hard disk devices of even larger capacities.

In order to achieve both increases in recording capacities and decreases in prices of magnetic recording apparatuses, it is effective to improve recording densities of magnetic recording media. The number of magnetic recording media required for a magnetic recording apparatus can be reduced by improving the recording densities, which leads to a reduction in the number of magnetic heads. As a result, price of a magnetic recording apparatus can be reduced due to the decrease in the number of components.

Improvement of recording densities of magnetic recording media requires improvement in resolution and improvement in the signal-to-noise ratio (S/N ratio). Noise reduction of a magnetic recording medium has been conventionally accomplished by reducing the diameter of magnetic particles forming a recording layer and, further, magnetically isolating the magnetic particles in the magnetic recording medium, as well as by suppressing the effect of the magnetic domain of a soft magnetic underlayer (SUL), which is provided under the recording layer and forms a magnetic reflux passage.

FIG. 1 shows the basis of magnetic recording using a perpendicular magnetic recording medium.

With reference to FIG. 1, over a substrate 1, a ferromagnetic recording layer 3 having an easy axis of magnetization perpendicular to the substrate surface is formed on top of a soft magnetic underlayer 2. Information is recorded in the ferromagnetic recording layer 3 by magnetic flux emitted from a recording magnetic pole 4A of a magnetic head 4 and perpendicularly passing through the ferromagnetic recording layer 3. The magnetic flux passing through the ferromagnetic recording layer 3 flows back to a reflux pole 4B of the magnetic head 4 via the soft magnetic underlayer 2.

Conventionally, the soft magnetic underlayer 2 is formed to have an amorphous structure or a microcrystalline structure in order to prevent the occurrence of medium noise and spike noise due to disturbance in the magnetic reflux flowing through the soft magnetic underlayer 2. Nonetheless, in the case where a magnetic domain is present in the soft magnetic underlayer 2, the magnetization perpendicular to the substrate surface occurs in the domain wall, thus the soft magnetic under-layer 2 is not able to prevent noise.

In order to reduce the noise problem of the soft magnetic underlayer 2, the APS-SUL (anti-parallel structured soft magnetic underlayer) configuration and technology have been proposed. According to the APS-SUL, the soft magnetic underlayer 2 includes a first soft magnetic layer 2A and a second soft magnetic layer 2B with a non-magnetic intermediate layer 2C interposed between them, as illustrated in FIG. 2 which shows a perpendicular magnetic recording medium according to a related art case of the present disclosure. The soft magnetic layers 2A and 2B are antiferromagnetically coupled so that the soft magnetic layers 2A and 2B together exhibit no remanent magnetization. Herewith, the influence of the domain in one soft magnetic layer is canceled out by the influence of the domain in the other soft magnetic layer.

However, since such APS-SUL technology does not prevent the formation of the domains in the soft magnetic layers 2A and 2B, there are limitations in reducing noise, thus posing obstacles to further increases in recording densities.

### [Patent Document 1] Japanese Patent Publication No. 3350512

[Non-patent Document 1] U.S. Pat. No. 6,641,935
[Non-patent Document 2] U.S. Pat. No. 6,660,357

### SUMMARY

According to another aspect of the present disclosure, a perpendicular magnetic recording medium includes a substrate; a soft magnetic underlayer disposed on the substrate and having no remanent magnetization; and a ferromagnetic recording layer disposed on the soft magnetic underlayer. The soft magnetic underlayer includes at least three soft magnetic layers laid one above the other with a non-magnetic intermediate layer interposed between every two adjacent soft magnetic layers. Among the three soft magnetic layers, at least one pair of soft magnetic layers form ferromagnetic coupling. Among the three soft magnetic layers, at least one pair of soft magnetic layers form antiferromagnetic coupling.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 shows an overview of perpendicular magnetic recording technology;

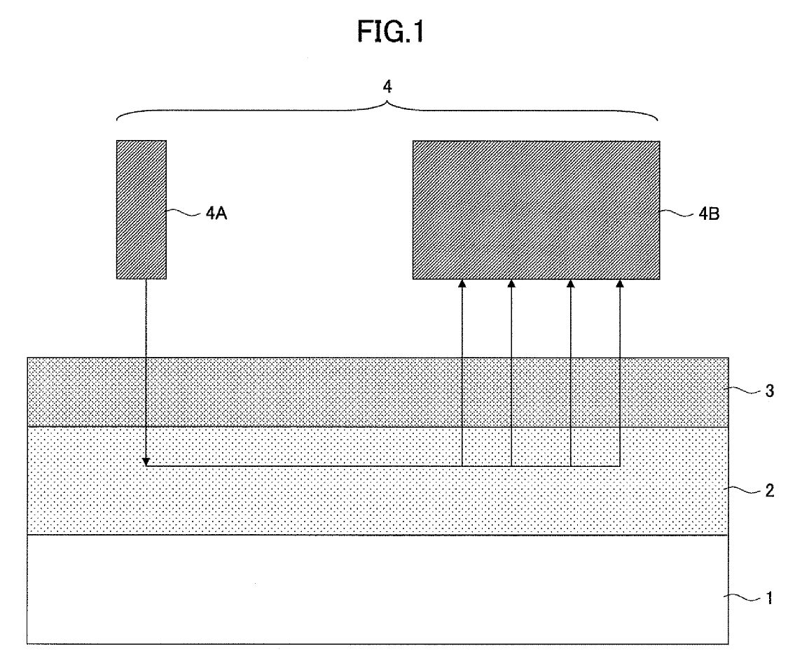

FIG. 2 shows a structure of a perpendicular magnetic recording medium according to a related art case of the present disclosure;

FIG. 3 shows a structure of a perpendicular magnetic recording medium according to the first embodiment of the present disclosure;

FIG. 4 shows a relationship between thickness of a Ru film and an exchange magnetic field between a pair of FeCoB films having the Ru film between them;

FIG. 5A shows the domain patterns observed in a soft magnetic underlayer used in the perpendicular magnetic recording medium of FIG. 3; and FIG. 5B shows a domain observed in a soft magnetic underlayer used in the perpendicular magnetic recording medium of FIG. 2;

FIG. 6A shows magnetization characteristics of the soft magnetic underlayer of the perpendicular magnetic recording medium of FIG. 3; and FIG. 6B shows magnetization characteristics of the soft magnetic underlayer of the perpendicular magnetic recording medium of FIG. 2;

FIGS. 7A and 7B show coercivity Hc and a reverse magnetic domain nucleation field Hn, respectively, of the perpendicular magnetic recording medium of FIG. 3, in comparison to those of the perpendicular magnetic recording medium of FIG. 2;

FIGS. 8A and 8B show medium noise Nm and an S/N ratio S/Nt, respectively, of the perpendicular magnetic recording medium of FIG. 3, in comparison to those of the perpendicular magnetic recording medium of FIG. 2;

FIGS. 9A and 9B show a write core width WCW and dual-frequency overwrite characteristics OW2, respectively, of the perpendicular magnetic recording medium of FIG. 3, in comparison to those of the perpendicular magnetic recording medium of FIG. 2;

FIG. 10 shows a structure of a perpendicular magnetic recording medium according to the second embodiment of the present disclosure;

FIG. 11 shows a domain observed in a soft magnetic underlayer used in the perpendicular magnetic recording medium of FIG. 10; and

FIG. 12 shows a structure of a magnetic recording apparatus according to the third embodiment of the present disclosure.

### DESCRIPTION OF EMBODIMENTS

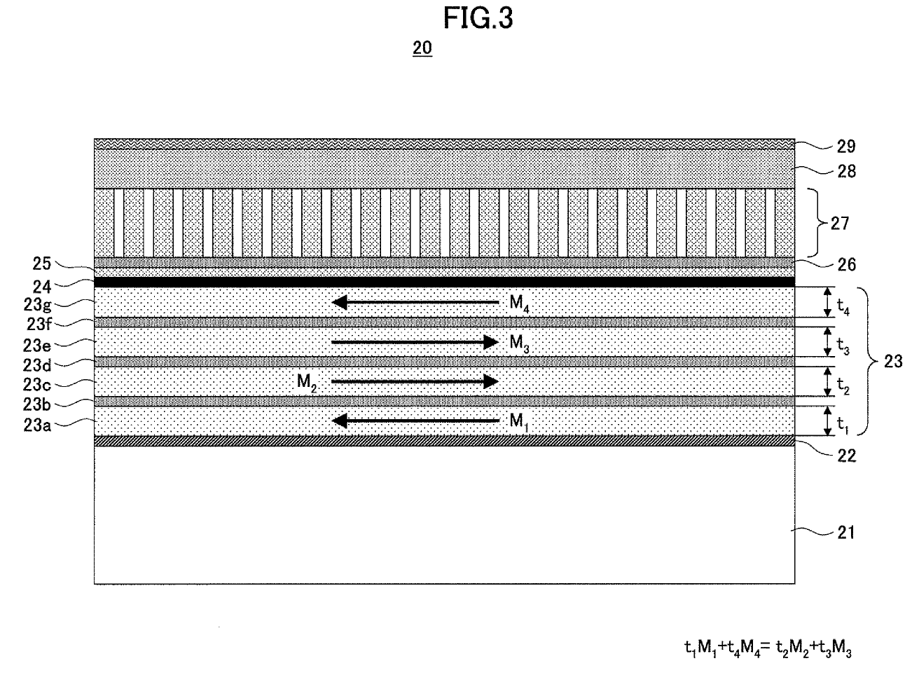

FIG. 3 shows the structure of a perpendicular magnetic recording medium 20 according to the first embodiment of the present disclosure.

With reference to FIG. 3, the perpendicular magnetic recording medium 20 includes, as a structural base, a non-magnetic substrate 21, such as a glass substrate. The perpendicular magnetic recording medium 20 includes a seed layer 22, which is a Cr film formed in a thickness of, for example, about 3 nm on the substrate 21 by sputtering under the conditions of a film-forming pressure of 0.3 to 0.8 Pa and a film-forming speed of, for example, 5 nm/second.

Note that the substrate 21 is not limited to a glass substrate, and may be a plastic substrate, an aluminum alloy substrate which is plated with a NiP film, or a silicon substrate. Furthermore, in the case where the recording medium is a flexible tape, the substrate 21 may be made of, for example, PET (polyethylene terephthalate), PEN (polyethylene naphthalate), or polyimide.

On the seed layer 22, a soft magnetic underlayer 23 having a magnetization of 0.5 to 2.4 T is formed in a thickness of 80 to 120 nm. The soft magnetic underlayer 23 includes amorphous soft magnetic FeCoB alloy layers 23a, 23c, 23e and 23g, each of which has a thickness of 20 to 30 nm and is formed by sputtering under the conditions of a film-forming pressure of 0.3 to 0.8 Pa and a film-forming speed of about 0.5 nm/second; and non-magnetic intermediate layers 23b, 23d and 23f, such as Ru films, each of which is sandwiched between two adjacent soft magnetic layers. Note however that the soft magnetic layers 23a, 23c, 23e and 23g are not limited to FeCoB alloy layers. A material suitable in order to reduce spike noise would be one that can be transformed to an amorphous phase, resist corrosion, reduce the film stress and optimize the magnetic characteristics. For example, an Fe alloy, a Co alloy or a Ni alloy may be used, and FeCoB, FeCoZrTa and CoZrTa are examples of such. In addition, such an alloy may include an element of C, B, Cu, Ta, Ti, V, Nb, Zr, Pt, Pd or the like. The soft magnetic underlayer 23 should be formed in such a manner as to satisfy the following relationship between thicknesses t₁, t₂, t₃ and t₄ and magnetization M₁, M₂, M₃ and M₄ of the soft magnetic layers 23a, 23c, 23e and 23g, respectively, so that zero magnetization is obtained for the entire soft magnetic underlayer 23: t₁M₁+t₄M₄=t₂M₂+t₃M₃.

The Ru films 23b, 23d and 23f are formed by sputtering under the conditions of a film-forming pressure of 0.3 to 1 Pa and a film-forming at the rate of ˜0.004 nm/W·sec. In the formation, the Ru films 23b and 23f are adjusted to have such a thickness that antiferromagnetic coupling is obtained between the soft magnetic layers 23a and 23c and between the soft magnetic layers 23e and 23g. Also, the Ru film 23d is arranged to have such a thickness that ferromagnetic coupling is obtained between the soft magnetic layers 23c and 23e.

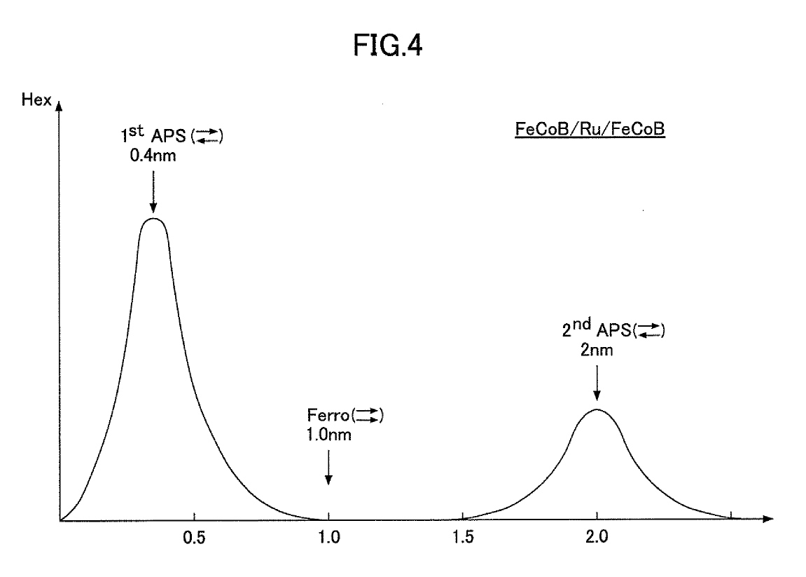

FIG. 4 shows the relationship between an exchange magnetic field Hex and thickness of a Ru film in an FeCoB/Ru/FeCoB structure.

With reference to FIG. 4, the exchange magnetic field Hex has a first local maximal value, which is the largest value, when the Ru film has a thickness of 0.4 nm, and has a second local maximal value when the Ru film has a thickness of 2.0 nm. In these cases, the directions of the magnetizations in the FeCoB layers having the Ru film between them become anti-parallel to each other. In the case where the Ru film has a thickness of 1.0 nm, the exchange magnetic field Hex becomes zero, and the directions of the magnetizations in the FeCoB layers sandwiching the Ru film become parallel to each other.

Accordingly, in the structure illustrated in FIG. 3, the directions of the magnetizations in the soft magnetic layers 23a and 23c are anti-parallel to each other, those in the soft magnetic layers 23c and 23e are parallel to each other, and those in the soft magnetic layers 23e and 23g are anti-parallel to each other.

Note that the non-magnetic intermediate layers 23b, 23d and 23f are not limited to Ru films, and may be Cr or Cu transition metal element films or Ir, Rh or Re rare-earth metal films. In the case of using any of such films, the thicknesses of the non-magnetic intermediate layers 23b, 23d and 23e are arranged, based on a relationship similar to the one illustrated in FIG. 4, in such a manner that the exchange magnetic field Hex has a local maximal value—preferably, the largest local maximal value—in each antiferromagnetically-coupled soft magnetic layer pair, and the exchange magnetic field Hex reaches zero in the ferromagnetically-coupled soft magnetic layer pair.

On top of the soft magnetic underlayer 23, a Ta film is formed as a seed layer 24 in a thickness of, for example, 3 nm by sputtering under the conditions of a film-forming pressure of 0.3 to 0.8 Pa and a film-forming speed of, for example, 5 nm/second. Then, on top of the seed layer 24, a soft magnetic FeNi alloy film is formed as an orientation control layer 25 in a thickness of about 5 nm under the conditions of a film-forming pressure of 0.3 to 0.8 Pa and a film-forming speed of, for example, 5 nm/second. FeNi particles in the orientation control layer 25 formed in this manner do not carry over the surface condition of the soft magnetic underlayer 23, and are able to form a favorable face-centered cubic (fcc) structure. Note that the orientation control layer 25 is not limited to an FeNi alloy film, and may be a Pt film, a Pd film, a NiFeSi alloy film, an Al film, a Cu film or a In film, for example. As the seed layer 24, a carbon film may be used.

On top of the orientation control layer 25, a Ru film having a hexagonal closest-packed (hcp) structure is formed as a non-magnetic intermediate layer 26 in a thickness of about 10 nm by sputtering under the conditions of a film-forming pressure of 4 to 10 Pa and a film-forming speed of, for example, 0.5 nm/second. The Ru film serving as the non-magnetic intermediate layer 26 has a hcp structure, which exhibits favorable lattice matching with the underlying orientation control layer 25 having the fcc structure. As a result, the orientation of the non-magnetic intermediate layer 26 is controlled in a predetermined direction, for example, a (0002) orientation, and the non-magnetic intermediate layer 26 exhibits excellent orientation. Note that the orientation control layer 26 is not limited to a Ru film, and may be a hcp structure film made of an alloy of Ru and any of Co, Cr, W and Re.

In the magnetic recording medium 20, a main recording layer 27 and a sub-recording layer 28 are sequentially disposed on top of the non-magnetic intermediate layer 26 by sputtering.

Specifically, on the non-magnetic intermediate layer 26, the main recording layer 27 is formed in a thickness of 12 nm by sputtering in an Ar atmosphere which includes traces of oxygen (for example, at a concentration of 0.2% to 2%), with the use of CoCrPt alloy targets (e.g. the composition is Co₇₀Cr₁₀Pt₂₀) and SiO₂ targets. The sputtering is performed by applying high-frequency power of 400 to 1000 W between the targets and the in-process substrate under the conditions of a film-forming pressure of 3 to 7 Pa, a film-forming rate of, for example, 5 nm/second and a substrate temperature of 10 to 80° C.

The main recording layer 27 formed in this manner has a so-called granular structure in which CoCrPt magnetic particles are dispersed in a SiO₂ grain boundary phase. The CoCrPt particles grow under the orientation control of the underlying non-magnetic intermediate layer 26, and become hexagonal cylindrical particles having a hcp structure, each particle of which extends in a direction substantially perpendicular to the main surface of the substrate 21. The easy axis of magnetization is oriented in the extending direction of the cylindrical particles. In this case, therefore, in the main recording layer 27, the easy axis of magnetization is oriented in a direction substantially perpendicular to the surface of the substrate 21. It is preferable that the grain boundary phase be included in the main recording layer 27 at 5 to 15%, and in the present embodiment, the percentage of the grain boundary phase is about 7%.

By using such a granular-structure magnetic layer for the main recording layer 27, individual magnetic particles in the main recording layer 27 are isolated from each other and aligned in a uniform easy axis of magnetization. Accordingly, medium noise attributed to the main recording layer 27 is reduced.

In the case where the magnetic particles include 25 atomic % or more of Pt, a magnetic anisotropy constant Ku of the main recording layer 27 decreases. Therefore, the magnetic particles preferably include 25 atomic % or less of Pt.

In particular, isolation of the magnetic particles in the main recording layer 27 is accelerated by, in the film-forming process of the main recording layer 27, adding traces of oxygen gas to the Ar sputtering gas at 0.2% to 2%, thereby reducing playback noise.

Alternatively, in order to accelerate isolation of the magnetic particles in the main recording layer 27, irregularity of the surface (indented surface) of the non-magnetic layer 26 may be increased. Such surface irregularity of the non-magnetic layer 26 is increased by forming the Ru film serving as the non-magnetic layer 26 at a low film-forming speed of about 0.5 nm/second, as mentioned above.

The grain boundary phase in the main recording layer 27 is not limited to a SiO₂ film, and may include another nonmagnetic material, for example, an oxide such as Ti oxide, Cr oxide or Zr oxide, or a nitride such as Si nitride, Ti nitride, Cr nitride or Zr nitride.

The magnetic particles in the main recording layer 27 are not limited to CoCrPt alloy particles, and may be another kind of CoCr alloy particles or FePt alloy particles. The crystal structure of the magnetic particles may be a honeycomb chained triangle (HCT) structure. Ag may be added to the FePt alloy.

On top of the main recording layer 27, a CoCr alloy film is formed as the sub-recording layer 28 by sputtering in an Ar-gas atmosphere. For example, the sub-recording layer 28 may be formed of a CoCrPtB alloy at a composition of Co₆₇Cr₁₉Pt₁₀B₄ under the conditions of a film-forming pressure of 0.3 to 0.8 Pa and a film-forming speed of 5 nm/second.

The CoCrPtB alloy formed in this manner has a continuous film structure, and is formed of magnetic particles aligned adjacent to each other. The magnetic particles in the sub-recording layer 28 form a hcp structure, as in the case of the magnetic particles in the main recording layer 27, and favorable lattice matching is achieved between the main recording layer 27 and the sub-recording layer 28. That is, the sub-recording layer 28 having excellent crystallinity is formed on the main recording layer 27.

Forming such a continuous sub-recording layer 28 on the granular-structure main recording layer 27 allows easy writing of magnetic information to the main recording layer 27. The sub-recording layer 28 may be formed under the main recording layer 27.

According to the perpendicular magnetic recording medium 20 of FIG. 3, on top of the sub-recording layer 28 formed in this manner, a protective film 29 formed of a DLC (diamond-like carbon) film is formed by plasma CVD.

Specifically, the substrate 21 above which the sub-recording layer 28 has been formed is placed in a treatment vessel of a plasma CVD apparatus. Then, C₂H₂ is supplied into the vessel as a material gas, and high-frequency power of 1000 W is applied under the condition of a film-forming pressure of 4 Pa, whereby the DLC film functioning as the protective film 29 is formed, on the sub-recording layer 28, in a thickness of about 4 nm.

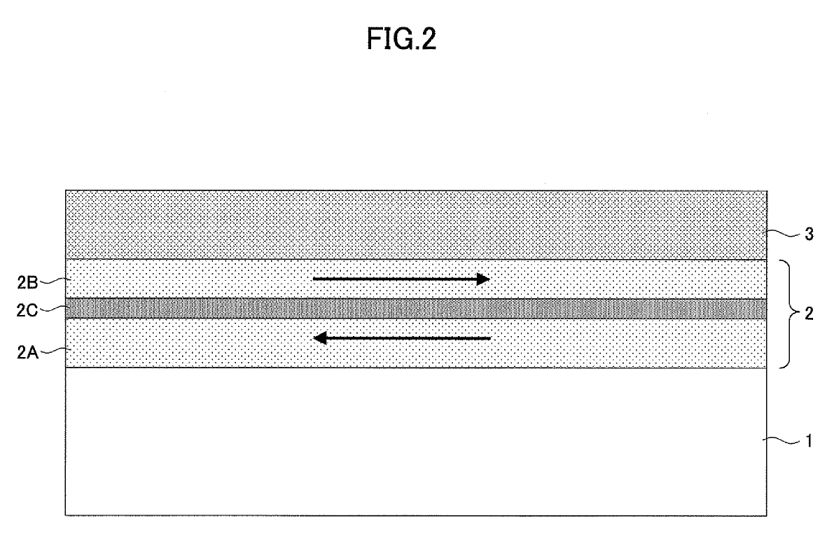

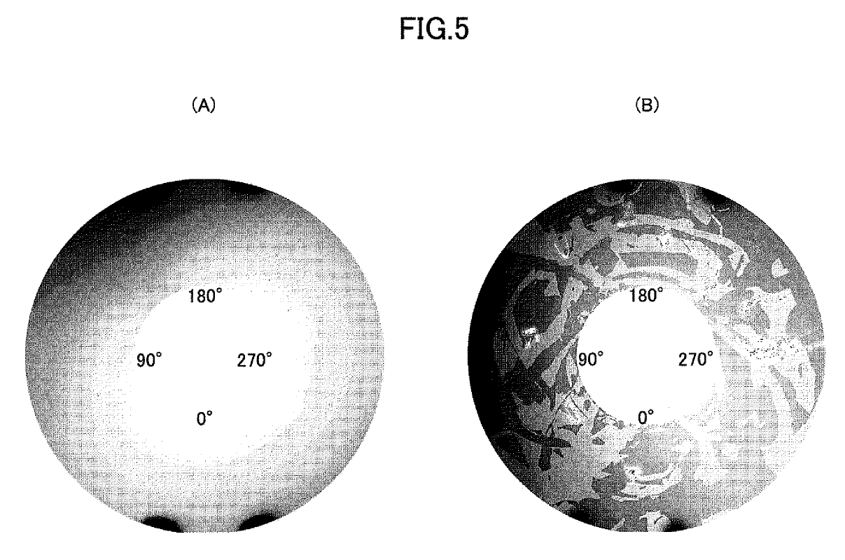

FIG. 5A is an OSA (optical surface analyzer) image of the surface of the soft magnetic underlayer 23, which is used in the perpendicular magnetic recording medium 20 made in the above described manner. FIG. 5B is an OSA image of the surface of the soft magnetic underlayer 2, which is used in the magnetic recording medium of FIG. 2 (the related art of the present disclosure). The soft magnetic underlayer 2 includes only a pair of antiferromagnetically-coupled soft magnetic layers.

With reference to FIG. 5A, in the magnetic recording medium 20 of the present embodiment, a pattern indicating a boundary of domains (magnetic domains) is absent in the soft magnetic underlayer 23, and it can be seen that a single domain is formed.

On the other hand, in the perpendicular magnetic recording medium of FIG. 2 (the related art of the present disclosure), complex domain boundaries are formed in the soft magnetic underlayer 2, which are sources of medium noise.

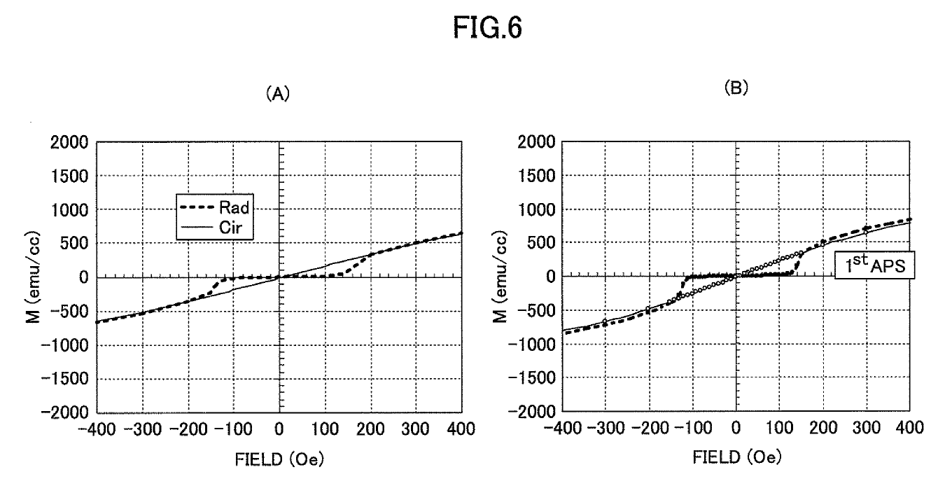

FIG. 6A shows a magnetization curve of the soft magnetic underlayer 23 of the perpendicular magnetic recording medium 20 illustrated in FIG. 3. FIG. 6B shows a magnetization curve of the soft magnetic underlayer 2 of FIG. 2, including only a pair of antiferromagnetically-coupled soft magnetic layers. The magnetization curve of the soft magnetic underlayer 2 is provided as a comparative reference.

With reference to FIGS. 6A and 6B, it is understood that the magnetization curve of the soft magnetic underlayer 23 including a pair of ferromagnetically-coupled soft magnetic layers matches the magnetization curve of the soft magnetic underlayer 2, and that there is no remanent magnetization.

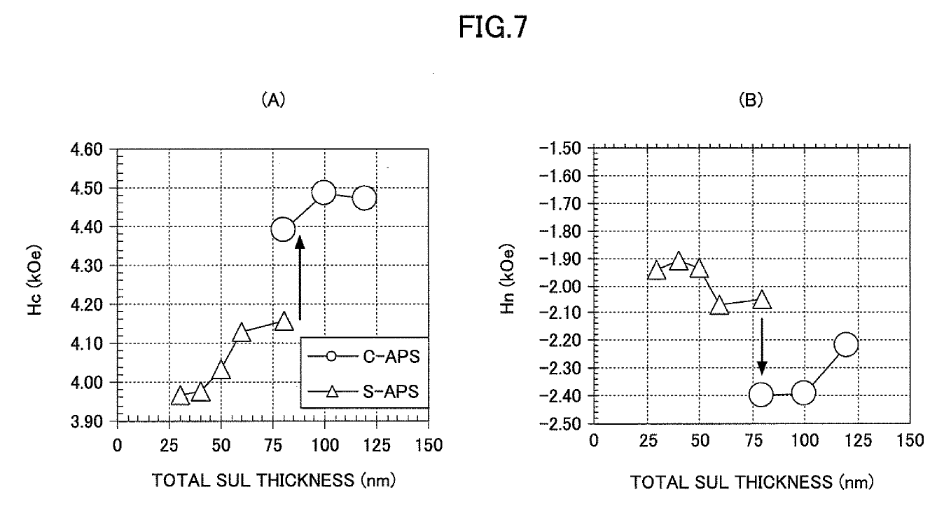

FIG. 7A shows the relationship between coercivity Hc and thickness of the soft magnetic underlayer 23, and FIG. 7B shows the relationship between a reverse magnetic domain nucleation field Hn and thickness of the soft magnetic underlayer 23. These relationships are obtained by actually performing writing and reading on the perpendicular magnetic recording medium 20 of FIG. 3. In FIGS. 7A and 7B, the relationships obtained from the perpendicular magnetic recording medium of FIG. 2, in which the main recording layer 27 and sub-recording layer 28 are provided on the soft magnetic underlayer 2, are also presented as comparative references.

With reference to FIGS. 7A and 7B, the soft magnetic underlayer 23 of the perpendicular magnetic recording medium 20 according to the present embodiment is 80 to 120 nm in thickness, being thicker than the comparative soft magnetic underlayer 2. It is understood that both the coercivity Hc and the reverse magnetic domain nucleation field Hn of the soft magnetic underlayer 23 are significantly larger than those of the comparative soft magnetic underlayer 2.

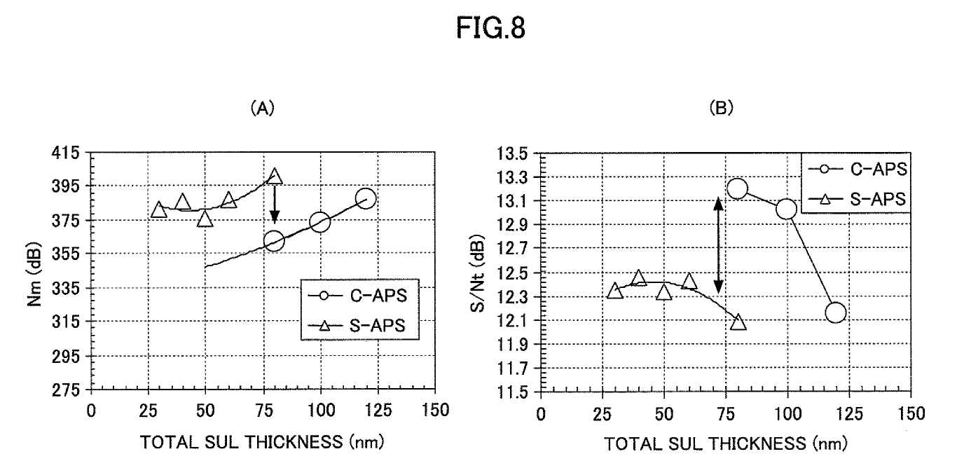

FIG. 8A shows the relationship between medium noise Nm and thickness of the soft magnetic underlayer 23, and FIG. 8B shows the relationship between an SN ratio S/Nt and thickness of the soft magnetic underlayer 23. In FIGS. 8A and 8B, the relationships obtained from the perpendicular magnetic recording medium of FIG. 2 are also presented as comparative references. The relationships of FIGS. 8A and 8B are obtained by actually performing writing and reading on the perpendicular magnetic recording media.

With reference to FIGS. 8A and 8B, the perpendicular magnetic recording medium 20 of the present embodiment shows a significant improvement in both the medium noise and the SN ratio compared to the comparative references.

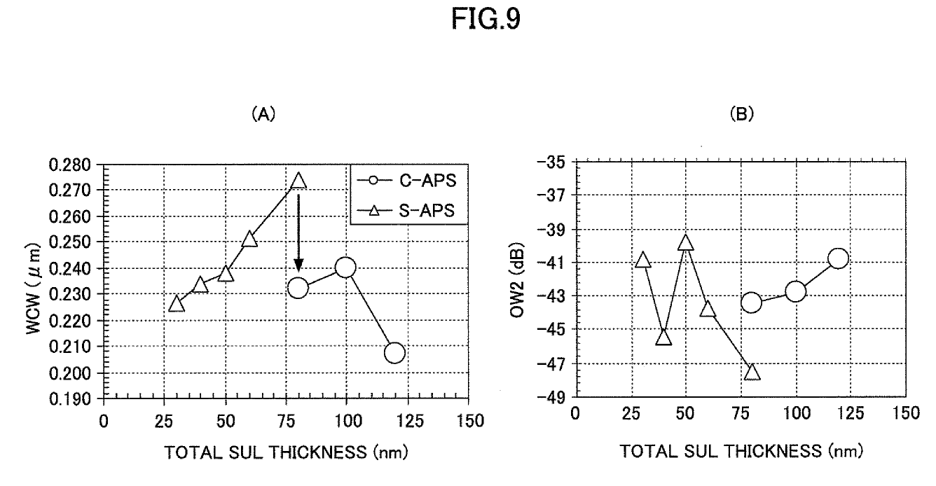

FIG. 9A shows the relationship between write core width, WCW of the perpendicular magnetic redording medium 20 of FIG. 3 and thickness of the soft magnetic underlayer 23, and FIG. 9B shows the relationship between dual-frequency overwrite characteristics OW2 and thickness of the soft magnetic underlayer 23. The overwrite characteristics OW2 are measured in such a manner that a low-frequency signal of 100 kfci is written to the magnetic recording medium 20, then a high-frequency signal of 500 kfci is written, and subsequently the low-frequency signal of 100 kfci is read. Having a larger absolute value of the dual-frequency overwrite characteristics OW2 means a better perpendicular magnetic recording medium.

With reference to FIGS. 9A and 9B, for the same thickness of the soft magnetic underlayer, the write core width of the perpendicular magnetic recording medium 20 of the present embodiment is significantly reduced, and the dual-frequency overwrite characteristics OW2 of the present embodiment is equivalent to those of the comparative reference.

### Second Embodiment

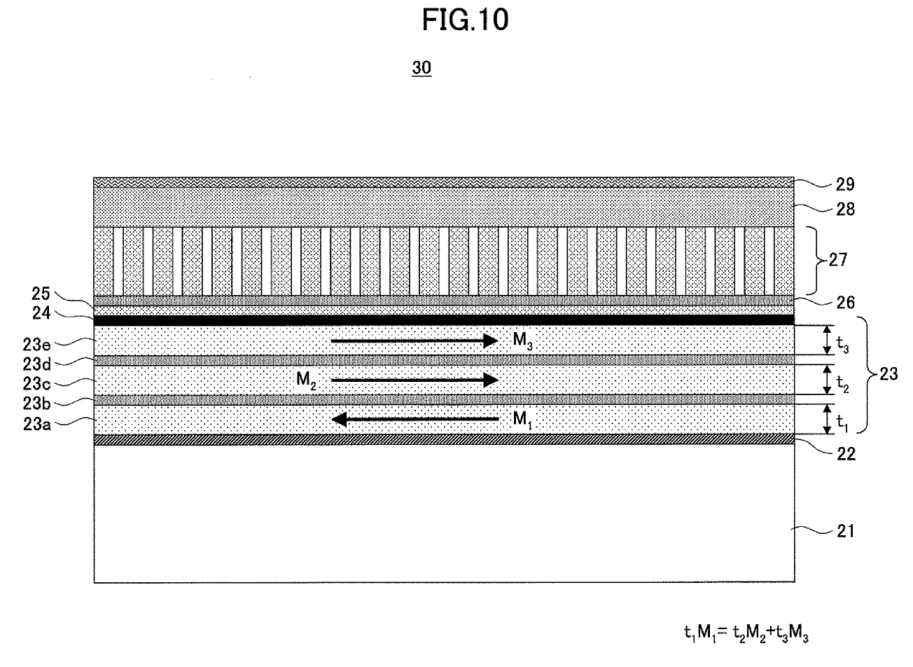

FIG. 10 shows the structure of a perpendicular magnetic recording medium 30 according to the second embodiment of the present disclosure. In FIG. 10, the same reference numerals are given to the components which are common to those in the above description, and their explanations are omitted.

With reference to FIG. 10, the perpendicular magnetic recording medium 30 of the present embodiment does not include the Ru film 23f and the soft magnetic layer 23g, and the Ru intermediate layer 24 is formed directly on the soft magnetic layer 23e. The soft magnetic underlayer 23 should be formed in such a manner as to satisfy the following relationship between the thicknesses t₁, t₂, and t₃ and the magnetization M₁, M₂ and M₃ of the soft magnetic layers 23a, 23c and 23e, respectively, so that zero remanent magnetization is obtained for the entire soft magnetic underlayer 23: t₁M₁=t₂M₂+t₃M₃.

In the example illustrated in FIG. 10, the soft magnetic layers 23a, 23c and 23e are made of an FeCoB alloy, the non-magnetic intermediate layer 23b is formed of an Ru layer having a thickness of 0.4 nm, and the non-magnetic intermediate layer 23d is formed of an Ru layer having a thickness of 1.0 nm.

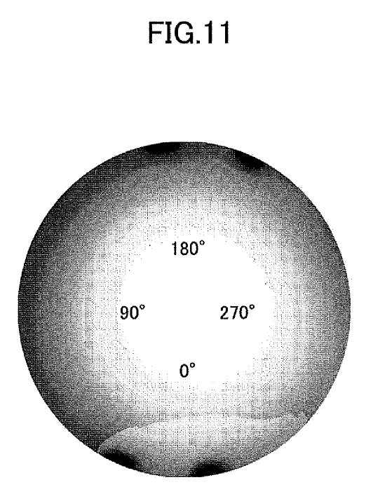

FIG. 11 shows a polarizing microscope photograph of the surface of the soft magnetic underlayer 23 including a pair of antiferromagnetically-coupled magnetic layers and a pair of ferromagnetically-coupled magnetic layers.

With reference to FIG. 11, although a magnetic domain boundary is observed at one location, it is seen that the magnetic domain is almost lost as in the case of FIG. 5A, and a structure close to a single magnetic domain is achieved.

Thus, the present disclosure is based on a finding that magnetic domains in the soft magnetic underlayer can be controlled by providing paired ferromagnetically-coupled soft magnetic layers in the soft magnetic underlayer, which includes at least one pair of antiferromagnetically-coupled soft magnetic layers. Note that the present invention is not limited to having a single pair of ferromagnetically-coupled soft magnetic layers, and multiple pairs of such layers may be provided.

### Third Embodiment

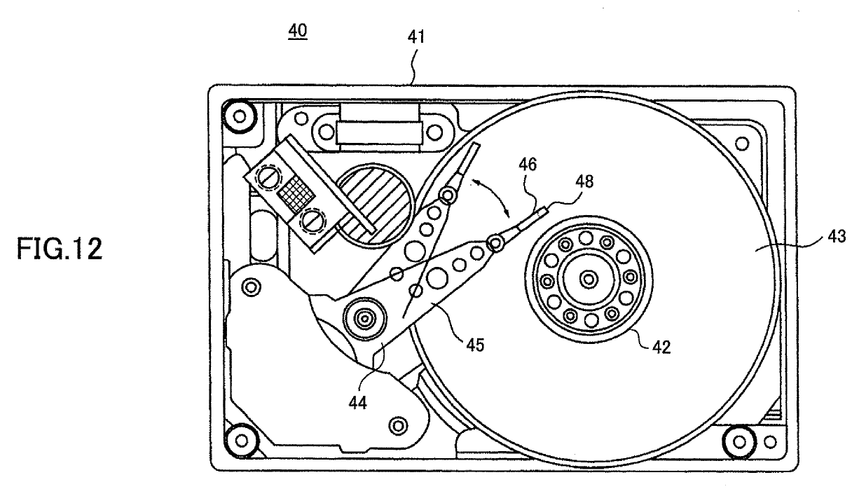

FIG. 12 shows a magnetic recording apparatus 40 according to the third embodiment of the present disclosure.

With reference to FIG. 12, the magnetic recording apparatus 40 includes a housing 41, in which the following are provided: a hub 42 driven by a spindle (not shown); a perpendicular magnetic recording medium 43 fixed to and rotated by the hub 42; an actuator unit 44; an arm 45 and a suspension 46 attached to the actuator unit 44 and moved in a radial direction of the perpendicular magnetic recording medium 43; and a magnetic head 48 supported by the suspension 46.

In the magnetic recording apparatus 40 of FIG. 12, the perpendicular magnetic recording medium 20 or 30 according to the first or the second embodiment is used as the perpendicular magnetic recording medium 43. Although FIG. 12 shows only one perpendicular magnetic recording medium 43, the present invention is not limited to this case, and two or more magnetic recording media may be used. In such a case, it is sufficient in the present disclosure if at least one of the multiple magnetic recording media is the perpendicular magnetic recording medium 20 or 30 of the first or the second embodiment.

Note that the magnetic recording apparatus 40 of the present embodiment is not limited to the one illustrated in FIG. 12. The perpendicular magnetic recording medium 43 used in the present invention is not limited to a magnetic disk, and may be a magnetic tape.

Thus, the present disclosure is based on a finding that magnetic domains in the soft magnetic underlayer can be controlled by providing paired ferromagnetically-coupled soft magnetic layers in the soft magnetic underlayer, which includes at least one pair of antiferromagnetically-coupled soft magnetic layers. The soft magnetic underlayer of the perpendicular magnetic recording medium is formed as follows. At least three soft magnetic layers are provided with a non-magnetic intermediate layer interposed between every two adjacent soft magnetic layers. Among the soft magnetic underlayers, at least one pair of soft magnetic underlayers form ferromagnetic coupling, and at least one pair of soft magnetic underlayers form antiferromagnetic coupling. As a result, it is possible to prevent domain formation in the soft magnetic underlayer, thereby reducing medium noise of the magnetic recording medium.

Thus, the present invention has been described herein with reference to preferred embodiments thereof. While the present invention has been shown and described with particular examples, it should be understood that various changes and modification may be made to the particular examples without departing from the scope of the broad spirit as defined in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiments of the present disclosure have been described in detail, it should be understood that various changes, substitutions, and alterations could be made hereto without departing from the spirit and scope of the invention.

What is claimed is:

1. A perpendicular magnetic recording medium comprising:
a substrate;
a soft magnetic underlayer disposed on the substrate and having no remanent magnetization; and
a ferromagnetic recording layer disposed on the soft magnetic underlayer;
wherein the soft magnetic underlayer includes at least three soft magnetic layers laid one above the other with a non-magnetic intermediate layer interposed between every two adjacent soft magnetic layers,
among the (at least) three soft magnetic layers, at least one pair of soft magnetic layers form ferromagnetic coupling, and
among the (at least) three soft magnetic layers, at least one pair of soft magnetic layers form antiferromagnetic coupling.

2. The perpendicular magnetic recording medium as claimed in claim 1, wherein in the soft magnetic under layer, two pairs of soft magnetic layers form antiferromagnetic coupling.

3. The perpendicular magnetic recording medium as claimed in claim 1, wherein in the at least one pair of the soft magnetic layers forming antiferromagnetic coupling, each non-magnetic intermediate layer has such a thickness that an exchange magnetic field between the at least one pair of the soft magnetic layers forming antiferromagnetic coupling takes a local maximal value, and in the at least one pair of the soft magnetic layers forming ferromagnetic coupling, each non-magnetic intermediate layer has such a thickness that an exchange magnetic field between the at least one pair of the soft magnetic layers forming ferromagnetic coupling takes a local minimal value.

4. The perpendicular magnetic recording medium as claimed in claim 3, wherein the thickness of each non-magnetic intermediate layer in the at least one pair of the soft magnetic layers forming antiferromagnetic coupling is arranged such that the exchange magnetic field takes a largest local maximal value, and the thickness of each non-magnetic intermediate layer in the at least one pair of the soft magnetic layers forming ferromagnetic coupling is arranged such that the exchange magnetic field becomes zero.

5. The perpendicular magnetic recording medium as claimed in claim 1, wherein only a single magnetic domain is formed in the soft magnetic udnerlayer.

6. The perpendicular magnetic recording medium as claimed in claim 1, wherein each of the at least three soft magnetic layers is made of an alloy chiefly including one selected from the group consisting of Fe, Co and Ni, and including at least one selected from the group consisting of Cr, B, Cu, Ta, Ti, V, Nb, Zr, Pt and Pd.

7. The perpendicular magnetic recording medium as claimed in claim 1, wherein the at least three soft magnetic layers are made of an alloy chiefly including one selected from the group consisting of Fe, Co and Ni, and including at least one selected from the group consisting of Cr, B, Cu, Ta, Ti, V, Nb, Zr, Pt and Pd, and each non-magnetic intermediate layer is a Ru film having a thickness of 0.4 nm.

8. The perpendicular magnetic recording medium as claimed in claim 1, wherein the at least three soft magnetic layers have a total thickness of 120 nm or less.

9. The perpendicular magnetic recording medium as claimed in claim 1, wherein the ferromagnetic recording layer chiefly includes Co.

10. A magnetic recording apparatus comprising:
a perpendicular magnetic recording medium;
a magnetic head configured to scan the perpendicular magnetic recording medium; and
a driving system configured to cause the magnetic head to scan the perpendicular magnetic recording medium;
wherein the perpendicular magnetic recording medium includes a substrate, a soft magnetic underlayer disposed on the substrate and having no remanent magnetization, and a ferromagnetic recording layer disposed on the soft magnetic underlayer,
the soft magnetic underlayer includes at least three soft magnetic layers laid one above the other with a non-magnetic intermediate layer interposed between every two adjacent soft magnetic layers, and
among the (at least) three soft magnetic layers, at least one pair of soft magnetic layers form ferromagnetic coupling, and
among the at least three soft magnetic layers, at least one pair of soft magnetic layers form antiferromagnetic coupling.
